(19) United States
(12) Patent Application Publication
(10) Pub. No.: US 2010/0217673 A1
(43) Pub. Date: Aug. 26, 2010

(54) DEVICE AND METHOD FOR THE CUSTOMISED DELIVERY OF TARGETED ADVERTISEMENTS FROM A LOCAL SERVER

(75) Inventor: Jean-Jacques Vandewalle, Lille-Hellemmess (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Meudon (FR)

(21) Appl. No.: 12/682,630

(22) PCT Filed: Sep. 30, 2008
(86) PCT No.: PCT/EP2008/063072

§ 371 Date: Apr. 12, 2010

(30) Foreign Application Priority Data
Oct. 12, 2007 (EP) 07301461.5

(51) Int. Cl. G06Q 30/00

(52) U.S. Cl. 705/14.64; 705/14.49; 705/14.66

(57) ABSTRACT

The invention relates to a device and methods for the customised delivery of targeted advertisements from a local server. In particular, the invention relates to the advertising server embedded in an electronic device and to the delivery and updating methods necessary for the operation thereof. According to the invention, the impact of the delivered advertising is optimised since the advertising content presented to the public matches each individual's requirements and centres of interest. Age, sex and geographical location are examples of criteria employed according to the invention.

The invention relates to a device and methods for the customised delivery of targeted advertisements from a local server.

The invention more particularly relates to an advertisement server embedded in an electronic device and the delivery and updating methods required for the operation thereof.

In order to deliver advertisements on an electronic device two policies currently exist:

According to a first possibility, the advertisement is stationary. This is the case where advertising inserts are inserted once and for all in their media when these are created. Such solution is for example used for associating advertisement with the utilisation of some software. Upon the launching of the software at stake, during the loading, an advertising image is displayed for a few seconds.

This solution has numerous drawbacks, among other things, too important a rigidity thereof. As a matter of fact, if a user has been using the software for 5 years, the advertising message, which was pertinent at the date of stake of the software, very unlikely is still today. In addition, this solution makes it possible to provide a so-called wide advertisement, i.e. intended to the whole public, without distinction of age, sex and any other criterion. This leads to an advertisement which is not efficiently taken advantage of, since it does not matches the expectations or centres of interest of the public receiving the advertisements at stake.

A second solution consists in implementing advertising content servers and inserting, into identified media, links pointing to the contents of such servers. This solution is widely used in the world of the Internet. As a matter of fact, most of the current advertisements in the HTML (HyperText Markup Language) pages which can be consulted on the Internet, are only links to specialised servers. This solution makes it possible to solve the problem of the ageing of advertising contents, but on the other hand, this kind of advertisement reaches its target only if the server is accessible. Such constraint significantly limits the media capable of displaying such kind of advertising contents. This solution does not make it possible to solve the problem of targeted advertisements. As a matter of fact, the links implemented in this solution are static and they do not take into account possible parameters relative to the user of the electronic device.

The invention provides to solve these problems by providing a method for the off-line delivery of targeted advertising content. The invention also relates to a method for updating the content at stake and a device enabling the implementation thereof.

More precisely, the invention is a method for the delivery of an advertising content stored in a portable electronic device comprising:

a step of selection of at least one application also called the selected application

a step of delivery of said advertising content through said selected application.

In one embodiment of the invention, this method of delivery also includes a prior step of pre-selecting the advertising content prior to the storing thereof in the portable electronic device, according to at least one criterion relating to the holder of the portable electronic device.

In one embodiment of the invention, the selected application is hosted by a second electronic device connected to said portable electronic device.

The step of delivery may consist in locating at least one advertising space in the selected application, then modifying the advertising space at stake according to the content of the portable electronic device. Another way to carry out the step of delivery consists in inserting advertising links to the content of the portable electronic device, in areas of the man-machine interface of the selected application. A third solution to carry out the step of delivery consists in substituting advertising elements from the portable electronic device for at least a part of the man-machine interface of the selected application. In a fourth possibility, the step of delivery consists in triggering the displaying of windows to display the whole or a part of the advertising content stored in the portable electronic device, using the functionalities of the selected application.

The invention is also a method for updating an advertising content stored in a portable electronic device including:

a step of selection, consisting in selecting at least an advertising content remote server,

a step of sorting, consisting in selecting a sub-assembly of advertising contents of the remote server,

a step of downloading, during which the sub-assembly obtained during the step of sorting is copied into a non-volatile memory of the portable electronic device.

In one embodiment of the invention, the step of sorting is carried out according to at least one parameter from the portable electronic device. In other embodiments, at least one parameter used for the sorting can originate from the second device, the behaviour analysis of the holder of the portable electronic device or even be supplied by the holder of the portable electronic device.

The invention also relates to a portable electronic device storing, in a non-volatile memory, an advertising content and having means capable of:

selecting at least one application, also called the selected application,

providing the delivery of the advertising content through the selected application.

In one embodiment of the invention, the portable electronic device includes means for sorting and downloading a remote advertising content.

In one embodiment of the invention, the portable electronic device includes communication means for selecting a selected application hosted by a second electronic device connected to the portable electronic device.

In various embodiments, the device can include means for locating at least one advertising location in the selected application, modifying the advertising space according to the content of the portable electronic device. In one mode, it could include means for inserting advertising links to the content of the portable electronic device in areas of the man-machine interface. It can also include means for substituting advertising elements from the portable electronic device for at least a part of the man-machine interface of the selected application. In another possible embodiment, it can include means for triggering the displaying of windows in order to display the whole or a part of the advertising content stored in the portable electronic device, using the functionalities of the selected application.

It should be noted that the man-machine interface, such as mentioned in the present invention, should be understood as a man-machine interface (IHM) in the software meaning of the term. As a matter of fact, the IHM which we mention can be described by a sound or graphic assembly of screens and input parameters making it possible for some software to deliver information to a user, and for the user to supply the information required for the operation of the software at stake. The best known IHMs are, for example, those in “Microsoft Windows”, which includes a central area, a strip also called a “task bar”, which includes a button “start”.

Another IHM is, for example, the WEB browser “Microsoft Internet Explorer”. The IHM of this software has a characteristic in that it has a large central part updated according to external data. Such data are in fact the HTML (HyperText Markup Language) pages, and thus the content of the HTML pages displayed complete the browser IHM.

Other characteristics and advantages of the invention will appear clearly when reading the following description thereof, given as an indication and not as a limitation, and referring to the appended drawings, wherein:

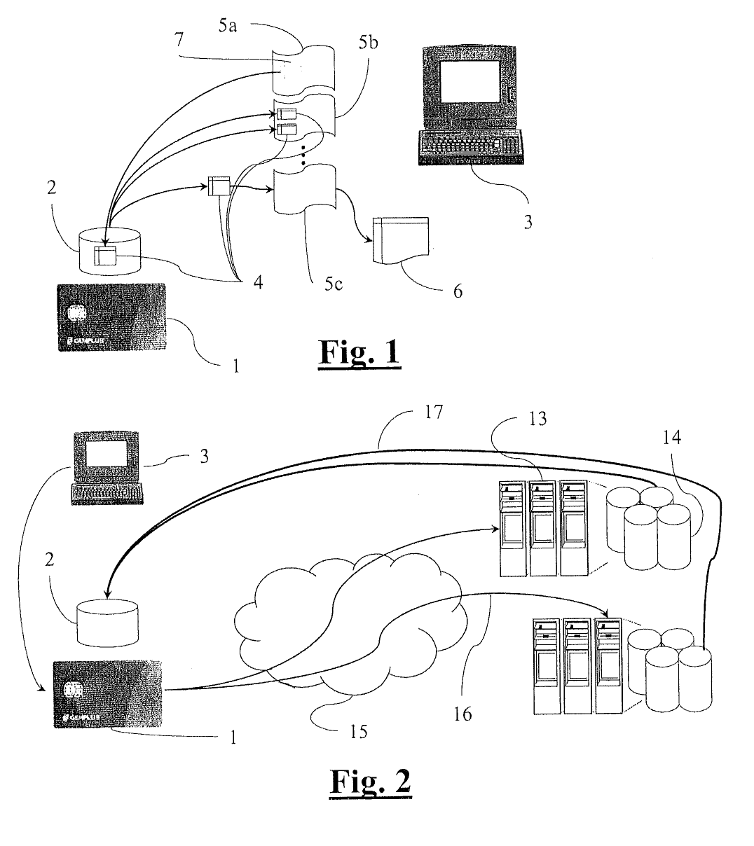

FIG. 1 shows an embodiment, wherein a portable electronic device is capable of delivering information;

FIG. 2 shows an embodiment, wherein a portable electronic device is capable of updating its own content;

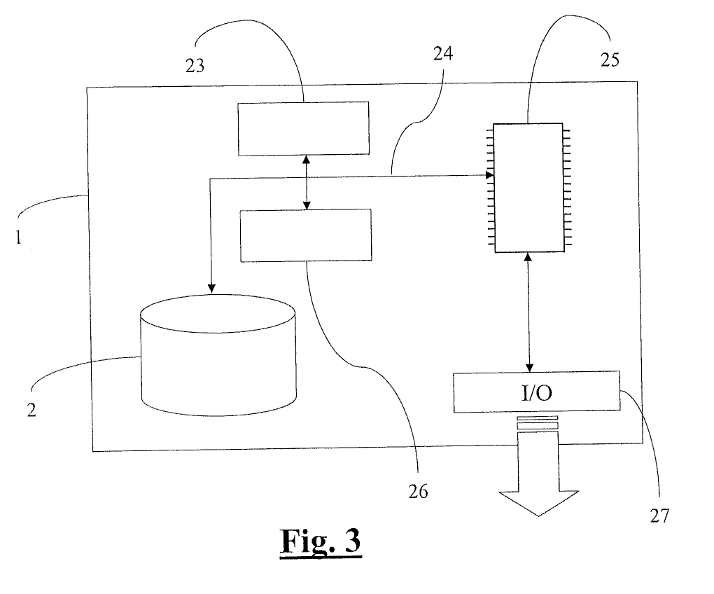

FIG. 3 shows a portable electronic device capable of delivering information and updating its own content.

FIG. 1 shows a portable electronic device 1. This device can, for example, be a chip card. Such card contains a non-volatile memory 2, which contains advertising contents. It should be advisable for the content existing on the card to be selected upstream, so as to be totally adapted to the holder, the holder being the person whom the utilisation of the card is dedicated to.

In addition, such card has means for delivering advertising contents through third party applications 5a, 5b, 5c. “Delivery of information” means the action which consists in having the information at stake and the user directly related. For example, the display of an automatic window (pop-up) on the foreground of the screen is a delivery. Similarly, if an application for playing a sound content is being executed, one can reasonably think that the user is listening to the flow of audio data. Then, the audio delivery with a volume higher than the volume of the current audio flow is a delivery of the information at stake.

In FIG. 1, the chip card will select one or several among the applications 5a, 5b, 5c at its disposal and will provide the delivery of the whole or a part of the advertising contents it contains.

The selection of the application which will be used for delivering the contents can be made by any means. The application can be selected according to one or several parameter(s) such as the location thereof in the memory, the name, the signature thereof, or any other parameter. Such selection can be made through a dedicated application or through a delivery application which will also be in charge of the delivery of the advertising content. The selection of the application and the delivery of the contents can also be initiated or not by the chip card acting as a local contents server.

In a first example, the chip card is inserted into a computer 3. Then, it can select one of the applications 5a, 5b, 5c existing on the computer. It should be noted that, according to the applications, it is possible to select applications either installed on the computer or being executed.

From then on, the card will deliver the content according to the delivery means at its disposal.

For example, the card selects an Internet browser 5a which is being executed. From then on, the card executes an application of delivery which first analyses the content of the HTML pages displayed by the browser 5a. If such pages contain links 7 to advertising contents stored on external media, then the delivery application will then re-orientate the links 7 at stake to advertising contents 4 stored in the card 1 non-volatile memory 2.

If the delivery application detects static advertising contents stored in the HTML pages, it can substitute the content from the non-volatile memory 2 for such content.

The application of the delivery can also insert an advertising content in a selected application which is not initially provided for this purpose. For example, the selected application can be a text processing application 5b. The delivery application analyses the information displayed by such text processing application and according to some criteria, inserts advertising inserts. For example, if the text displayed by the text processing application contains a blank space of at least four centimetres by four centimetres, then an advertising insert 4 from the card is inserted in such available space.

The delivery application may modify any part of the IHM of the selected application. For example, it can be considered to insert advertising slogans in the contextual menus of the selected application.

Some applications have parameterisable IHMs. For example, Microsoft Windows XP uses a system of “themes”. This makes it possible to change the whole appearance of the IHM, for example, the form of the windows, the background of the contextual menus, the form of the characters used, the form of the mouse pointer, etc.

In this case, it is easy for the delivery application to modify the elements of the installed theme, using advertising elements 4 from the card non-volatile memory.

Another alternative delivery embodiment according to the invention consists in operating the displaying functionalities of the selected application. For example, if the selected application 5c is Microsoft Windows XP, it contains windows automatic displaying mechanisms (pop-up). It is thus possible to use such functionalities for displaying advertising contents 4. Then, the delivery application must format the advertising content 4 to make it comply With the requirements of the windows automatic displaying system and start the displaying thereof 6.

It should be reminded that in the example, the card 1 is inserted into the computer 3. The invention is also perfectly adapted to the devices 1 and 3, such as the wireless connections (Bluetooth, wifi, . . . ) or any other technology.

Similarly, the case shown in FIG. 1 with two independent devices 1 and 3 is only an exemplary embodiment of the invention. According to a second embodiment of the invention, one and only one device which contains both the non-volatile memory 2 contains the advertising data and the applications 5a, 5b, 5c.

FIG. 2 illustrates the process of loading the non-volatile memory 2 of an electronic device 1. It should be noted that the content is downloaded from one or several servers 13 having advertising contents 14. The connection between the card 1 and the servers 13 can be obtained through any media 15. A wire or direct connection, a wireless connection of the WIFI type or a more remote connection, for example through the Internet can be mentioned, for example.

In FIG. 2, the card 1 is inserted into the computer 3 which is connected to the Internet 15.

According to at least one predefined criterion, the card takes the initiative of updating its content. This criterion can, for example, be a criterion connected to the latest updating. As a matter of fact, the card may decide that after some time its content is no longer pertinent and thus must be renewed.

Using the computer 3 and the network 15, the card thus gets in contact with the server or servers 13. This connection is materialised by the arrows 16. From then on, the card selects a sub-assembly of contents 14 of said server or servers 13. This selection of contents can be obtained according to various parameters. This/these parameter or parameters can originate, for example, from the card, the computer, a behaviour analysis of the card holder or even directly from the cardholder.

Such parameters make it possible to adapt the advertising content to be downloaded to the cardholder. Then, it is particularly interesting to use criteria such as the holder's location, his or her age, his or her profession, his or her hobbies among other things. The downloading is illustrated by the arrows 17.

Upon completion of the sorting of the contents, the selected contents are downloaded into the card 1 non-volatile memory 2.

FIG. 3 shows a portable electronic device 1, for example, a wireless telephone having a non-volatile memory 2 wherein advertising contents are stored. This device also includes calculation means 25 and communication means 27.

The device 1 also includes means 23 for selecting at least a third party application to secure the delivery of the content through this application. In FIG. 3, the device also includes updating means 26 for sorting and downloading a distant advertising content.

In one embodiment, the delivery means 23 are implemented as a programme. This delivery programme is executed by a processor 25 which is used as calculation means, and searches the whole or a part of the advertising content in the non-volatile memory 22 and delivers it via the communication means 27, through a selected third application. This application can be found in another device connected with device 1 through communication means 27. Such communication means can be with a wire, but the invention is also adapted to a utilisation through wireless communication means.

This delivery programme may contain various delivery means for, for example:

locating at least one advertising space in the selected application, then modifying the content of the advertising space according to the content of the portable electronic device,

inserting advertising links to the content of the portable electronic device in areas of the man-machine interface matching predefined criteria,

substituting advertising elements from the portable electronic device for at least a part of the man-machine interface of the selected application,

and triggering the display of windows for displaying the whole or a part of the advertising content stored in the memory 2, using the functionalities of the selected application.

The optional updating means 26 are capable of selecting a remote content according to parameters, for example by adding a trademark on all the available distant contents, and sorting according to such trademark. According to a preferred example, it can be particularly interesting to affect information relating to the location of the point of sale to all the advertising contents. A wireless telephone 1 is capable of locating itself according to the GSM terminals which it is connected to. Then, upon the updating of the content of the memory 2, a strategy consists in selecting only advertisements which have a point of sale less than 10km away from the GSM terminal which the telephone is currently connected to.

A similar scheme can be implemented, based on the holder's age and hobbies, if such information is given by the user.

The programme 26 can also analyse some parameters and deduce parameters therefrom. In our exemplary portable telephone, the utilisation of some functionalities of the telephone, such as games or services like stars, make it possible to target a certain type of advertising content.

In the case where the selected means of an application are provided to select an application on another device, the transmission of the contents selection parameter or parameters can be carried out through the distant device.

1. A method for the delivery of an advertising content stored in a portable electronic device characterised in that it includes
a step of selection of at least one application called the selected application,
a step of delivery of said advertising content through said selected application.

2. A method according to claim 1,
characterised in that it includes a prior step of pre-selecting said advertising content prior to the storing thereof in said portable electronic device, according to at least one criterion relating to the holder of said electronic portable device.

3. A method according to claim 1 or 2,
characterised in that said selected application is hosted by a second electronic device connected to said electronic portable device.

4. A method according to any one of claims 1 to 3,
characterised in that the step of delivery consists in locating at least one advertising space in the selected application, then a modification of said advertising space according to the content of said electronic portable device.

5. A method according to any one of claims 1 to 3,
characterised in that the step of delivery consists in inserting advertising links to the content of said portable electronic device, in areas of the man-machine interface of said selected application.

6. A method according to claims 1 to 3,
characterised in that the step of delivery consists in substituting advertising elements from the portable electronic device for at least a part of the man-machine interface of the selected application.

7. A method according to any one of claims 1 to 3,
characterised in that the step of delivery consists in triggering the display of windows with a view to displaying the whole or a part of the advertising content stored in the electronic portable device, using the functionalities of the selected application.

8. A method for updating an advertising content stored in a portable electronic device
characterised in that it includes:
a step of selection, consisting in the selection of at least a remote server of advertising contents,
a step of sorting, consisting in the selection of a sub-assembly of advertising contents of said remote server
a step of downloading, during which said sub-assembly is copied into a non-volatile memory of said portable electronic device.

9. A method according to claim 8,
characterised in that the step of sorting is carried out according to at least one parameter from said portable electronic device.

10. A method according to claim 8,
characterised in that the step of sorting is carried out according to at least one parameter from said second electronic device.

11. A method according to claim 8,
characterised in that the step of sorting is carried out according to at least one parameter from a behaviour analysis of the holder of said portable electronic device.

12. A method according to claim 8,
characterised in that the step of sorting is carried out according to at least one parameter supplied by the holder of said portable electronic device.

13. A portable electronic device storing, in a non-volatile memory, an advertising content,
characterised in that it includes means capable of:
selecting at least one application called the selected application,
providing the delivery of said content through said selected application.

14. A device according to claim 13,
characterised in that it includes means for sorting and downloading a remote advertising content.

15. A device according to claim 13 or 14,
characterised in that it includes communication means for selecting an application hosted by a second electronic device connected to the portable electronic device.

16. A device according to any one of claims 13 to 15,
characterised in that it includes means for locating at least one advertising space in said selected application, modifying the content of said advertising space according to the content of said portable electronic device.

17. A device according to one of claims 13 to 15,
characterised in that it includes means for inserting advertising links to the content of the portable electronic device, in areas of the man-machine interface meeting predefined criteria.

18. A device according to any one of claims 13 to 15,
characterised in that it includes means for substituting advertising elements from the portable electronic device for at least a part of the man-machine interface of the selected application.

19. A device according to any one of claims 13 to 15,
characterised in that it includes means for triggering the displaying of windows to display the whole or a part of the advertising content stored in the portable electronic device, using the functionalities of the selected application.
